(19) United States
(12) Patent Application Publication
(10) Pub. No.: US 2009/0033959 A1
(43) Pub. Date: Feb. 5, 2009

(54) IMAGE FORMING APPARATUS AND STORAGE MEDIUM CONTROL METHOD THEREOF

(75) Inventor: Chi-tack CHANG, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/176,581

(22) Filed: Jul. 21, 2008

(30) Foreign Application Priority Data
Aug. 1, 2007 (KR) 2007-77429

(51) Int. Cl. G06F 15/00

(52) U.S. Cl. 358/1.9

(57) ABSTRACT

An image forming apparatus includes an interface which is connected with a storage medium to store printing data therein, an image forming unit to perform an image forming operation with respect to the printing data, a display unit, and a controller to control displaying whether to remove the storage medium depending on the image forming operation with respect to the printing data stored in the storage medium.

### CROSS-REFERENCE TO RELATED APPLICATIONS

This application claims priority under 35 U.S.C. §119(a) from Korean Patent Application No. 10-2007-0077429, filed on Aug. 1, 2007, in the Korean Intellectual Property Office, the disclosure of which is incorporated herein in its entirety by reference.

### BACKGROUND OF THE INVENTION

1. Field of the Invention

Apparatuses and methods consistent with the present general inventive concept relate to an image forming apparatus and a storage medium control method thereof, and more particularly, to an image forming apparatus which is connected with a storage medium, and a storage medium control method thereof.

2. Description of the Related Art

An image forming apparatus forms an image based on printing data. With the progress in memory-related technologies and improved functions of an image forming apparatus, the image forming apparatus receives various printing data through a predetermined data interface, instead of by a host device. Particularly, a storage medium which uses a universal serial bus (USB) interface has been popular since the respective storage medium is portable and has large storage capacity.

However, a conventional image forming apparatus does not have a module to safely remove the storage medium connected with the USB interface, unlike the host device. Also, a user does not know whether an image forming operation with respect to the printing data stored in the storage medium is being performed. Thus, if a user removes the storage medium from the image forming apparatus, the printing data stored in the storage medium may be lost or the image forming apparatus may be damaged.

Particularly, if a plurality of host devices is connected with the image forming apparatus through a network, the respective host devices know only information on the printing data therein. Thus, whether the image forming operation with respect to the printing data stored in the storage medium is being performed by other host devices is difficult to know.

### SUMMARY OF THE INVENTION

The present general inventive concept provides an image forming apparatus to display whether to remove a storage medium depending on an image forming operation performed with respect to printing data stored in the storage media, and to safely perform the image forming operation of the data stored therein, and a storage medium control method thereof.

The present general inventive concept also provides an image forming apparatus to display that a remote user is currently performing an image forming operation through an image forming apparatus so that a local user is notified of the operation, and to protect printing data stored in a storage medium, and a storage medium control method thereof.

The present general inventive concept also provides an image forming apparatus to enable and disable a data interface included in an image forming apparatus without difficulty, and a storage medium control method thereof.

Additional aspects of the present general inventive concept will be set forth in part in the description which follows and, in part, will be obvious from the description, or may be learned by practice of the present general inventive concept.

The foregoing and/or other aspects and utilities of the present general inventive concept are also achieved by providing an image forming apparatus including an interface which is connected with a storage medium to store printing data therein, an image forming unit to perform an image forming operation with respect to the printing data, a display unit, and a controller to control displaying whether to remove the storage medium depending on the image forming operation with respect to the printing data stored in the storage medium.

The controller may control displaying that the storage medium is not removable while the image forming operation is performed, and controls to display that the storage medium is removable while the image forming operation is not performed.

The controller may control displaying that the storage medium is a new storage medium if the storage medium is connected with the interface.

The controller may disable the storage medium from the interface if a predetermined first time is elapsed after removability of the storage medium is displayed.

The controller may disable a port corresponding to the storage medium through a port disable command.

The controller may not disable the storage medium if a user inputs a command within the first time.

The storage medium may be reconnectable with the interface after being disabled.

The printing data may store in the storage medium comprises printing data that is reserved to perform an image forming operation.

The storage medium may store port information on the printing data therein, and the controller determines whether the image forming operation is performed, based on the stored port information.

The foregoing and/or other aspects and utilities of the present general inventive concept are also achieved by providing an storage medium control method of an image forming apparatus which has an interface connected with a storage medium to store printing data therein, the control method comprising determining whether an image forming operation with respect to printing data stored in the storage medium is performed, and displaying whether to remove the storage medium depending on the determination on the image forming operation.

The displaying whether to remove the storage medium may comprise displaying that the storage medium is not removable if a determination is made that the image forming operation is being performed, and displaying that the storage medium is removable if a determination is made that the image forming operation is not performed.

The displaying whether to remove the storage medium may comprise displaying that the storage medium is a new storage medium if the storage medium is connected with the interface.

The displaying that the storage medium is removable may comprise disabling the storage medium from the interface if a preset first time is elapsed after removability of the storage medium is displayed.

The disabling the storage medium may comprise disabling a port corresponding to the storage medium through a port disables command.

The control method may comprise not disabling the storage medium if a user inputs a command within the first time.

The storage medium and the interface may be reconnectable with each other after the storage medium is disabled.

The printing data may store in the storage medium printing data that is reserved to perform an image forming operation.

The storage medium may store port information on the printing data, and the determining of whether the image forming operation may be performed comprises determining whether the image forming operation is performed based on the stored port information.

The foregoing and/or other aspects and utilities of the general inventive concept may also be achieved by providing a control method of an image forming apparatus, the method comprising determining and displaying a connection state of a storage memory to the image forming apparatus, and determining and displaying an operation state of the storage medium.

The determining and displaying the connection state may comprise determining one of whether the storage medium has been disconnected and whether a new storage medium is found.

The determining and displaying an operation state may comprise determining one of whether an image forming operation is currently using the storage medium and whether the image forming operation is finished using the storage medium.

The method may further comprise providing a user an opportunity to cancel the image forming operation when a determination is made that the image forming operation is currently using the storage medium.

The foregoing and/or other aspects and utilities of the general inventive concept may also be achieved by providing a computer-readable recording medium having embodied thereon a computer program to execute a method, wherein the method comprises determining and displaying a connection state of a storage memory to an image forming apparatus, and determining and displaying an operation state of the storage medium.

The foregoing and/or other aspects and utilities of the general inventive concept may also be achieved by providing an image forming apparatus usable with a detachable storage medium, the apparatus comprising an image forming unit to use printing data to perform an image forming operation, an interface to connect to and to transmit the printing data between the detachable storage medium and the image forming apparatus, and a controller to determine and to display a connection state and an operational state of the detachable storage medium.

### BRIEF DESCRIPTION OF THE DRAWINGS

The above and/or other aspects of the present general inventive concept will become apparent and more readily appreciated from the following description of the embodiments, taken in conjunction with the accompanying drawings of which:

FIG. 1 is a block diagram illustrating an image forming apparatus according to an exemplary embodiment of the present general inventive concept;

FIG. 2 is a block diagram illustrating an image forming apparatus according to an exemplary embodiment of the present general inventive concept;

FIG. 3 illustrates a user interface to display that an image forming operation with respect to printing data stored in a storage medium is being performed by an image forming apparatus according to an embodiment of the present general inventive concept;

FIGS. 4A to 4D illustrate user interfaces which are displayed to determine whether to remove the storage medium from the image forming apparatus according to an embodiment of the present general inventive concept;

FIG. 5 is a flowchart illustrating a storage medium control method of the image forming apparatus according to the present general inventive concept; and

FIGS. 6A to 6C are flowcharts illustrating a storage medium control method of an image forming apparatus according to another exemplary embodiment of the present general inventive concept.

### DETAILED DESCRIPTION OF THE PREFERRED EMBODIMENTS

Reference will now be made in detail to embodiments of the present general inventive concept, examples of which are illustrated in the accompanying drawings, wherein like reference numerals refer to the like elements throughout. The embodiments are described below in order to explain the present general inventive concept by referring to the figures.

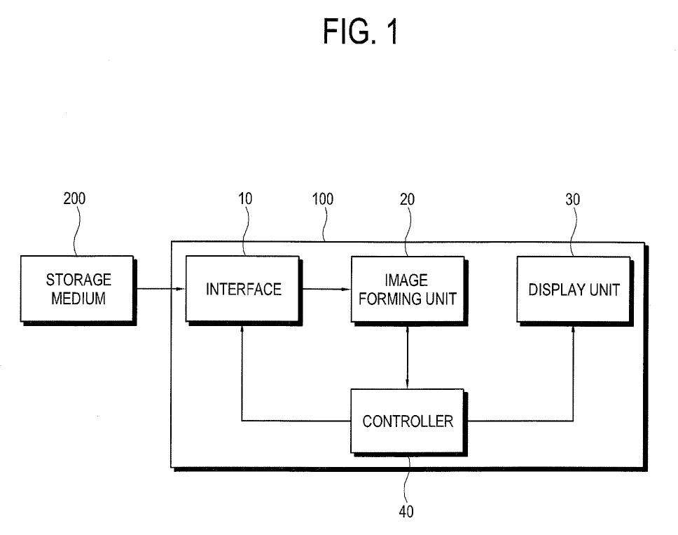

FIG. 1 is a block diagram illustrating an image forming apparatus 100 according to an exemplary embodiment of the present general inventive concept. As illustrated therein, the image forming apparatus 100 according to an exemplary embodiment of the present general inventive concept includes an interface 10, an image forming unit 20, a display unit 30 and a controller 40. The image forming apparatus 100 according to the present embodiment may include a multi functional peripheral (MFP) to perform multi functions, as well as a printer.

The interface 10 is connected with a storage medium 200 to store printing data therein. The interface 10 according to the present embodiment receives printing data according to a USB standard if the storage medium 200 includes a USB memory stick, but not limited thereto. Alternatively, the interface 10 may have various standards as long as the interface 10 can be connected with a portable external device. The printing data stored in the storage medium 200 may include text data, image data and other printable information files.

The image forming unit 20 forms an image based on the printing data. If the printing data stored in the storage medium 200 is received through the interface 10, the image forming unit 20 may perform an image forming operation with respect to the received printing data.

The image forming unit 20 according to the present embodiment may include a photosensitive body (not illustrated) to form an electrostatic latent image thereon, a developing unit (not illustrated) to develop a developer on the photosensitive body, and a transfer unit (not illustrated) to transfer the developer developed on the photosensitive body to a paper to form an image on the paper. The image forming unit 20 according to the present embodiment may further include a rendering module to perform data rendering so that the printing data is output to a recording medium.

The display unit 30 displays whether to remove the storage medium 20 and whether a new storage medium 200 is connected, according to a control of the controller 40 (to be described later). The display unit 30 according to the present embodiment displays whether to remove the storage medium 200 and whether the new storage medium 200 is connected. Alternatively, the display unit 30 may output a predetermined audio signal whether to remove the storage medium 20 and whether the new storage medium 200 is connected.

The controller 40 controls to display whether to remove the storage medium 200 depending on the image forming operation performed with respect to the printing data stored in the storage medium 200. More specifically, the controller 40 according to the present general inventive concept controls displaying that the storage medium 200 is not removable while the image forming operation with respect to the printing data received through the interface 10 is being performed. The controller 40 controls displaying that the storage medium 200 is removable if the image forming operation with respect to the printing data received through the interface 10 is not performed.

Here, the controller 40 may display that the storage medium 200 is not removable if the image forming operation with respect to the stored printing data is reserved and even if the operation is not currently performed.

The controller 40 may receive a job list including port information on the printing data from the interface 10 whether the image forming operation with respect to only the printing data stored in the storage medium 200 connected with the interface 10 is performed. If a determination is made that the printing data is stored in the storage medium 200 based on the received port information field, the controller 40 may control to display whether to remove the storage medium 200 depending on the image forming operation performed with respect to the printing data.

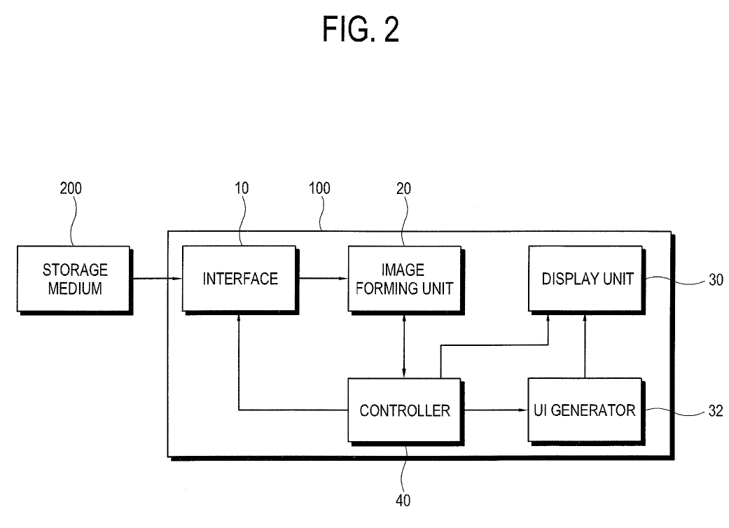

Hereinafter, an image forming apparatus 100 according to an exemplary embodiment of the present general inventive concept will be described with reference to FIG. 2.

As illustrated therein, the image forming apparatus 100 according to an exemplary embodiment of the present general inventive concept further includes a user interface (UI) generator 32.

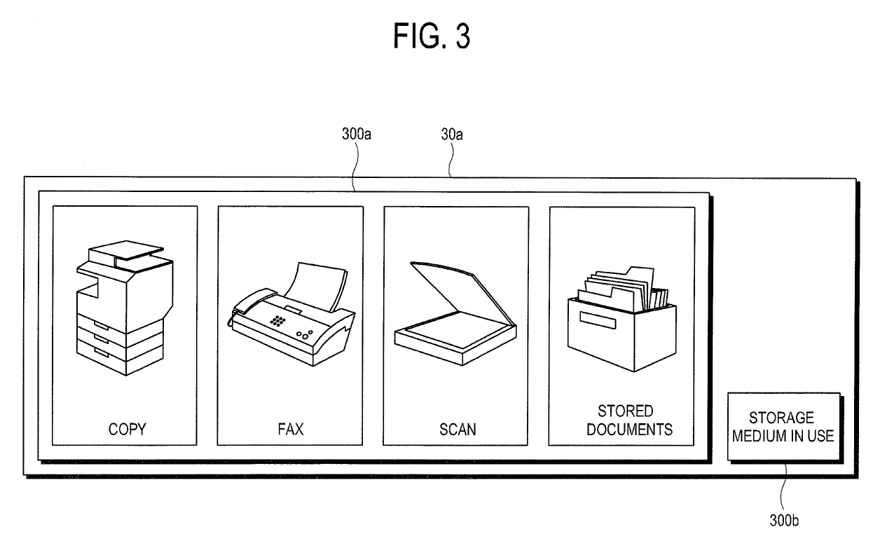

If a display unit 30 according to the present embodiment includes a liquid crystal display (LCD), the UI generator 32 generates a UI informing whether to remove a storage medium 200 according to a control of a controller 40. The UI which is generated by the UI generator 32 according to the present embodiment will be described with reference to FIG. 3.

Referring to FIGS. 2 and 3, a user interface 300b displays that an image forming operation with respect to printing data stored in the storage medium 200 is being performed. If the image forming operation with respect to the printing data stored in the storage medium 200 is being performed according to a user's command, the controller 40 controls the UI generator 32. Then, the UI generator 32 generates the user interface 300b displaying that the printing data stored in the storage medium 200 is received through the interface 10 and the storage medium 200 is in use, to be displayed on the display unit 30a.

The display unit 30a according to the present embodiment includes a touch panel to receive an input on desired operations of the image forming apparatus 100 from a user.

Then, a user may recognize that the storage medium 200 connected with the image forming apparatus 100 is being used, without difficulty.

The UI generator 32 according to the present embodiment may generate a user interface 300a to input a desired function among various functions of the MFP, by a user, and display the user interface 300a on the display unit 30a. However, the user interface 300a is not required to be simultaneously displayed with the user interface 300b displaying that the storage medium 200 is being used.

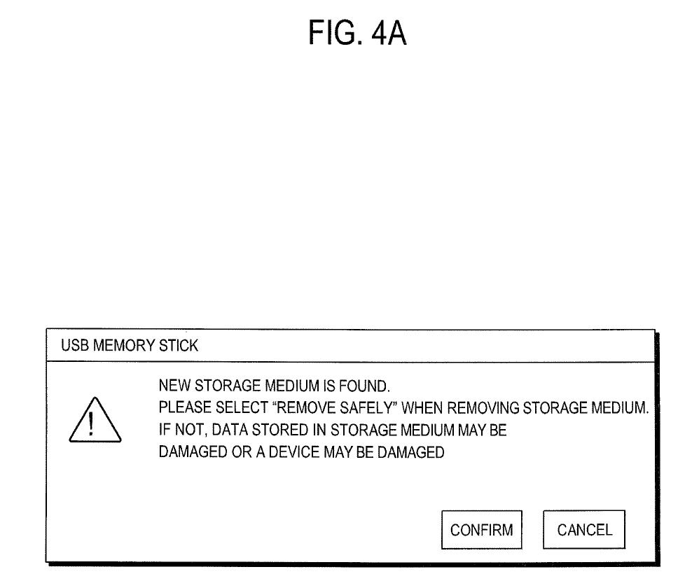

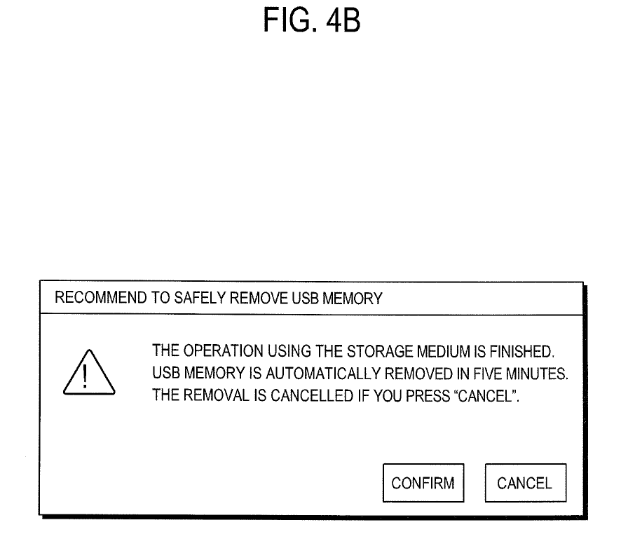

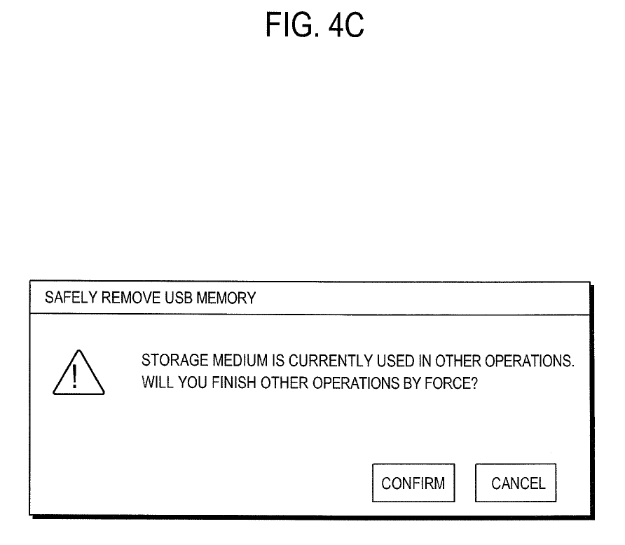

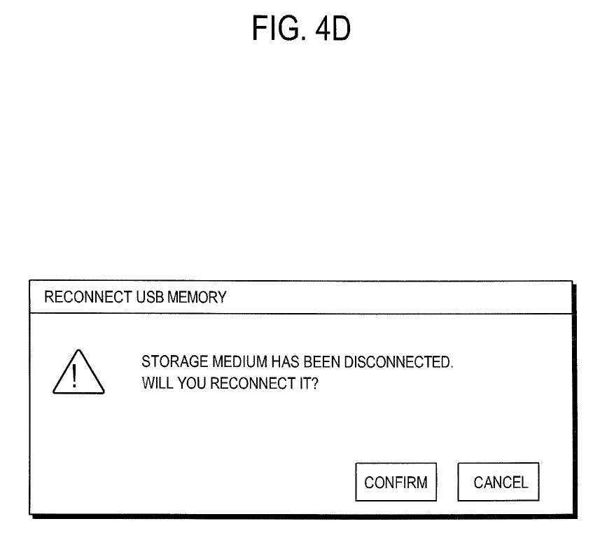

FIGS. 4A to 4D illustrates user interfaces on the removal of the storage medium 200 (FIG. 2) connected with the interface 10 (FIG. 2).

Referring to FIGS. 2 and 4A, a user interface displays a connection of the storage medium 200 if the storage medium 200 is connected with the interface 10. If the connection between the storage medium 200 and the interface 10 is detected and if the image forming operation with respect to the printing data stored in the storage medium 200 is finished, the controller 40 controls the UI generator 32. Then, the UI generator 32 generates the user interface so that a user safely removes the storage medium 200.

FIG. 4B is a user interface to display that the image forming operation with respect to the printing data stored in the storage medium 200 is finished. If a determination is made that the image forming operation with respect to the printing data stored in the storage medium 200 is finished and the stored printing data is not reserved to perform the image forming operation, the controller 40 disables the storage medium 200 from the interface 10 by a port disable command of a USB hub class. In this case, the controller 40 disables the storage medium 200 if a predetermined first time is elapsed after the removability of the storage medium 200 is displayed.

If a user inputs cancellation of removing the storage medium 200, the controller 40 may not disable the storage medium 200. Thus, a user may set whether to enable or disable the interface 10 connected with the storage medium 200 without difficulty.

FIG. 4C illustrates a user interface to display that the image forming operation with respect to the printing data stored in the storage medium 200 (FIG. 2) is being performed. Referring to FIGS. 2 and 4C, if a user inputs to stop performing the image forming operation, the controller 40 controls the image forming unit 20 to stop performing the image forming operation with respect to the printing data stored in the storage medium 200. Then, the printing data stored in the storage medium 200 is protected and the image forming apparatus 100 may not be damaged.

FIG. 4D illustrates a user interface to display a reconnection between the interface 10 (FIG. 2) and the storage medium 200 (FIG. 2) after the removal of the storage medium 200. Referring to FIGS. 2 and 4D, if the first time is elapsed after the storage medium is removed, the controller 40 may receive an input from a user whether to reconnect the storage medium 200 through the interface 10. If a user selects to reconnect the storage medium 200, the controller 40 connects the interface 10 and the storage medium 200 through a port enable command of a USB hub class. Thus, the interface 10 of the image forming apparatus 100 may be enabled or disabled without difficulty.

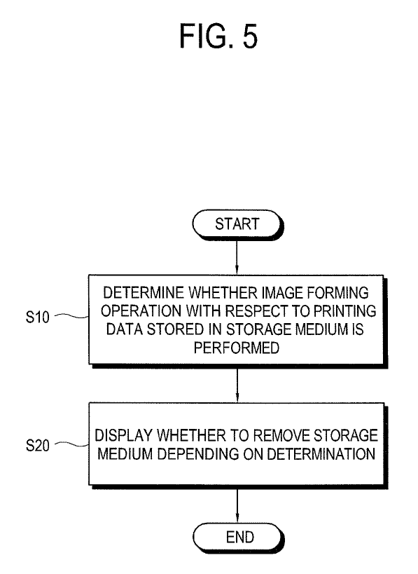

Hereinafter, a storage medium control method of the image forming apparatus 100 (FIG. 2) according to an embodiment of the present general inventive concept will be described with respect to FIG. 5.

Referring to FIGS. 2 and 5, the controller 40 determines whether the image forming operation with respect to the printing data stored in the storage medium 200 is performed (operation S10). The controller 40 controls displaying whether to remove the storage medium 200 according to the determination of the operation S10 (operation S20).

More specifically, if a determination is made that the image forming operation with respect to the printing data stored in the storage medium 200 is being performed, the operation S20 may display that the storage medium 200 is not removable. If a determination is made that the image forming operation with respect to the printing data stored in the storage medium 200 is not being performed, the operation S20 may display that the storage medium 200 is removable.

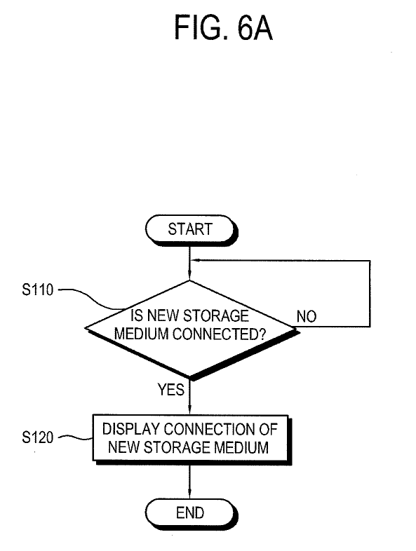

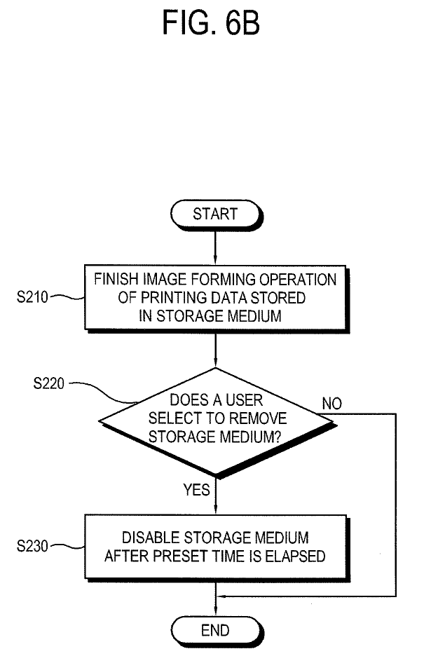

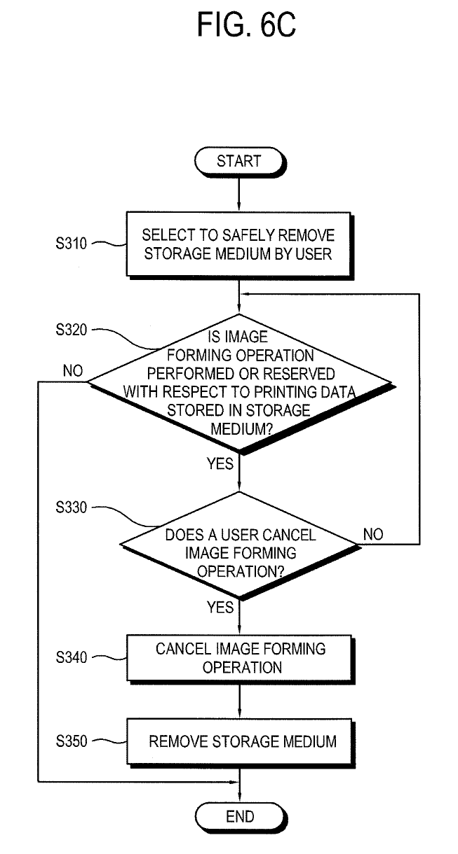

Hereinafter, a storage media control method of an image forming apparatus 100 (FIG. 2) according to another exemplary embodiment of the present general inventive concept will be described with reference to FIGS. 6A to 6C.

As illustrated in FIG. 6A, the controller 40 determines whether the new storage medium 200 is connected (operation S110), and displays the connection of the new storage medium 200 if a determination is made that the new storage medium 200 is connected (operation S120). Thus, a user may safely remove the newly-connected storage medium 200.

As illustrated in FIG. 6B, if a determination is made that the image forming operation with respect to the printing data stored in the storage medium 200 is finished or the image forming operation with respect thereto is not reserved (operation S210), the controller 40 controls displaying the determination and a user selects to remove the storage medium 200 (operation S220). Then, the storage medium 200 may be disabled after the predetermined time (operation S230).

As illustrated in FIG. 6C, if a user selects to remove the storage medium 200 (operation S310), the controller 40 determines whether the image forming operation with respect to the printing data stored in the storage medium 200 is being performed or reserved (operation S320). If a determination is made that the image forming operation is being performed or reserved and a user selects to stop performing the image forming operation (operation S330), the controller 40 controls the image forming unit 20 to stop performing the image forming operation (operation S340) and disables the storage medium 200 (operation S350).

The present general inventive concept can also be embodied as computer-readable codes on a computer-readable medium. The computer-readable medium can include a computer-readable recording medium and a computer-readable transmission medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

As described above, various embodiments of the present general inventive concept provide an image forming apparatus to display whether to remove a storage medium depending on an image forming operation performed with respect to printing data stored in the storage medium, and to safely perform the image forming operation with respect to the printing data stored in the storage medium, and a storage medium control method thereof.

Also, various embodiments of the present general inventive concept provide an image forming apparatus to display that a remote user is currently performing an image forming operation through an image forming apparatus so that a local user is notified of the operation, and to protect the printing data stored in the storage medium, and a storage medium control method thereof.

Further, various embodiments of the present general inventive concept provide an image forming apparatus to enable and disable a data interface included in the image forming apparatus, and a storage medium control method thereof.

Although various exemplary embodiments of the present general inventive concept have been illustrated and described, it will be appreciated by those skilled in the art that changes may be made in these exemplary embodiments without departing from the principles and spirit of the general inventive concept, the scope of which is defined in the appended claims and their equivalents.

What is claimed is:

1. An image forming apparatus, comprising:
an interface which is connected with a storage medium to store printing data therein;
an image forming unit to perform an image forming operation with respect to the printing data;
a display unit; and
a controller to control displaying whether to remove the storage medium depending on the image forming operation with respect to the printing data stored in the storage medium.

2. The image forming apparatus according to claim 1, wherein the controller controls displaying that the storage medium is not removable while the image forming operation is performed, and controls displaying that the storage medium is removable while the image forming operation is not performed.

3. The image forming apparatus according to claim 1, wherein the controller controls displaying that the storage medium is a new storage medium if the storage medium is connected with the interface.

4. The image forming apparatus according to claim 2, wherein the controller disables the storage medium from the interface if a predetermined first time is elapsed after removability of the storage medium is displayed.

5. The image forming apparatus according to claim 4, wherein the controller disables a port corresponding to the storage medium through a port disable command.

6. The image forming apparatus according to claim 4, wherein the controller does not disable the storage medium if a user inputs a command within the first time.

7. The image forming apparatus according to claim 4, wherein the storage medium is reconnectable with the interface after being disabled.

8. The image forming apparatus according to claim 1, wherein the printing data stored in the storage medium comprises:
printing data that is reserved to perform an image forming operation.

9. The image forming apparatus according to claim 1, wherein the storage medium further stores port information on the printing data therein, and the controller determines whether the image forming operation is performed, based on the stored port information.

10. A storage medium control method of an image forming apparatus which has an interface connected with a storage medium to store printing data therein, the control method comprising:
determining whether an image forming operation with respect to printing data stored in the storage medium is performed; and
displaying whether to remove the storage medium depending on the determination on the image forming operation.

11. The control method according to claim 10, wherein the displaying whether to remove the storage medium comprises:
displaying that the storage medium is not removable if a determination is made that the image forming operation is being performed; and
displaying that the storage medium is removable if a determination is made that the image forming operation is not performed.

12. The control method according to claim 10, wherein the displaying whether to remove the storage medium further comprises:
displaying that the storage medium is a new storage medium if the storage medium is connected with the interface.

13. The control method according to claim 11, wherein the displaying that the storage medium is removable further comprises:
disabling the storage medium from the interface if a preset first time is elapsed after removability of the storage medium is displayed.

14. The control method according to claim 13, wherein the disabling the storage medium comprises:
disabling a port corresponding to the storage medium through a port disable command.

15. The control method according to claim 13, further comprising:
not disabling the storage medium if a user inputs a command within the first time.

16. The control method according to claim 13, wherein the storage medium and the interface are reconnectable with each other after the storage medium is disabled.

17. The control method according to claim 11, wherein the printing data stored in the storage medium comprises:
printing data that is reserved to perform an image forming operation.

18. The control method according to claim 11, wherein the storage medium further stores port information on the printing data, and
the determining whether the image forming operation is performed comprises determining whether the image forming operation is performed based on the stored port information.

19. A control method of an image forming apparatus, the method comprising:
determining and displaying a connection state of a storage medium to the image forming apparatus; and
determining and displaying an operation state of the storage medium.

20. The method of claim 19, wherein the determining and displaying the connection state comprises:
determining one of whether the storage medium has been disconnected and whether a new storage medium is found.

21. The method of claim 20, wherein the determining and displaying an operation state comprises:
determining one of whether an image forming operation is currently using the storage medium and whether the image forming operation is finished using the storage medium.

22. The method of claim 21, further comprising:
providing a user an opportunity to cancel the image forming operation when a determination is made that the image forming operation is currently using the storage medium.

23. A computer-readable recording medium having embodied thereon a computer program to execute a method, wherein the method comprises: determining and displaying a connection state of a storage memory to an image forming apparatus; and
determining and displaying an operation state of the storage medium.

24. An image forming apparatus usable with a detachable storage medium, the apparatus comprising:
an image forming unit to use printing data to perform an image forming operation;
an interface to connect to and to transmit the printing data between the detachable storage medium and the image forming apparatus; and
a controller to determine and to display a connection state and an operational state of the detachable storage medium.
